(19) United States
(12) Patent Application Publication
(10) Pub. No.: US 2026/0024955 A1
(43) Pub. Date: Jan. 22, 2026

(54) Connector separation apparatus for electrical battery connections

(71) Applicant: Kory Miller, Bonnots Mill, MO (US)

(72) Inventor: Kory Miller, Bonnots Mill, MO (US)

(21) Appl. No.: 18/773,779

(22) Filed: Jul. 16, 2024

(51) Int. Cl. H01R 43/26; H01M 10/42

(52) U.S. Cl. CPC H01R 43/26; H01M 10/42; H01M 2220/20

(57) ABSTRACT

A battery connector separation apparatus comprises two insertion heads, a cap, an insertion chamber, and at least one guide pin. By aligning the two insertion heads parallel to each other, the insertion chamber is created for placing the connector. The apparatus is customizable for various connectors that can be inserted using interchangeable insertion heads. The apparatus is configured to mount onto a plier-like device with two handles, one pivot point, two jaws, and one compression spring. Separation occurs when the lower ends of pliers-like device handles are squeezed together after the connector is placed within the chamber. The disclosure herein details the customizable structure and method of use of the connector separation apparatus for electrical battery connections.

### CROSS-REFERENCE TO RELATED APPLICATIONS

This original Nonprovisional Application does not claim benefit to any prior applications.

### FEDERALLY SPONSORED RESEARCH AND DEVELOPMENT

Not applicable.

The present disclosure relates to an apparatus and method of use for a battery connector separation apparatus that detaches electrical connectors for batteries.

### BACKGROUND OF THE INVENTION

Electrical connectors are commonly used in the radio-controlled (RC) hobby industry. These connectors are particularly popular for connecting batteries to RC cars, helicopters, drones, and other RC devices due to their reliable connection and ability to handle high current loads.

There are several benefits to using these battery connectors, such as they provide a robust and reliable connection, so power loss is minimized. They are typically made of durable and strong materials that can withstand frequent unplugging, plugging, vibrations, and impacts commonly encountered across various applications. They are relatively easy to solder and install, making them a popular choice among hobbyists and professionals. Hobby shops and online retailers sell these connectors. However, separating these connectors can be difficult due to their size and/or an individual's abilities or possible lack thereof. The disclosure herein provides a solution to easily and quickly separate the battery connectors.

### SUMMARY OF THE INVENTION

In some aspects, the techniques described herein relate to the battery connector separation apparatus that may include two insertion heads, one cap, one insertion chamber, and at least one guide-pin, wherein the two insertion heads may be flush-aligned and parallel to each other, and the one cap may be horizontally aligned to the two insertion heads configured to form the one insertion chamber, and wherein the apparatus may be configured to mount onto a plier-like device.

In some aspects, the techniques described herein relate to an insertion chamber that may be 8.2 to 17.0 mm wide, 15.75 to 38.2 mm long, and 13.5 to 19.5 mm deep.

In some aspects, the techniques described herein relate to an apparatus, wherein the plier-like device may include two handles, one pivot point, and two jaws, wherein each handle may have an upper-handle-end and lower-handle-end, wherein each jaw may have an upper-jaw-end and a lower-jaw-end, where two lower-jaw-end of the two jaws and the upper-handle-ends of the two handles may be connected together at the pivot point, and wherein a one compression spring may be placed between the two upper-handle-ends and below the pivot point.

In some aspects, the techniques described herein relate to the jaws of a plier-like device that may include at least one mounting bolt on each jaw configured to mount securely by the mounting bolts, wherein the mounting bolts may be M4×10.

In some aspects, the techniques described herein relate to the compression spring of a plier-like device that may be 12 mm×30 mm.

In some aspects, the techniques described herein relate to an apparatus, wherein the one cap may include a rectangular cuboid, wherein the rectangular cuboid may have one top-cap-surface, one bottom-cap-surface, one back-cap-wall, one right-cap-wall, one left-cap-wall, and a front-cap-surface, wherein the top-cap-surface may be smooth-flat, the bottom-cap-surface may have two cavities divided by a middle-cap-wall, wherein the front-cap-surface may have two openings, wherein each opening may extend into the each cavity.

In some aspects, the techniques described herein relate to an apparatus, wherein right-cap-wall, back-cap-wall, and left-cap-wall each may have an outer side and an inner side, wherein the outer sides of right-cap-wall, back-cap-wall, left-cap-wall outer walls may be flat, and wherein the outer sides of left/right-cap-wall may have a tethering tool.

In some aspects, the techniques described herein relate to the two cap cavities that may be parallel to each other, wherein each cavity may be U-shaped and cylindrical shaped.

In some aspects, the techniques described herein relate to each cavity that may be 27.4 mm wide, 32.5 mm long, and 12.25 mm deep.

In some aspects, the techniques described herein relate to the bottom-cap-surface two cavities that may fit into the two insertion heads.

In some aspects, the techniques described herein relate to the insertion head that may include at least two components, wherein the first component may be an insertion-head-cavity configured to form half of the one insertion chamber, and wherein a second component may be a guide-pin-holder.

In some aspects, the techniques described herein relate to the guide-pin-holder, which may be a rectangular cuboid.

In some aspects, the techniques described herein relate to the first component that may further compromise a U-shaped cylindrical cavity that may include an upper-insertion-head-cavity-wall, a lower-insertion-head-cavity-wall, a semi-circular-back-insertion-head-cavity-wall, and two insertion-head-side-openings and one insertion-head-font-opening, and wherein the upper-insertion-head-cavity-wall and the lower-insertion-head-cavity-wall may be flat.

In some aspects, the techniques described herein relate to the second guide-pin-holder component that may be attached to a semi-circular-back-insertion-head-cavity-wall of the insertion-head-cavity and wherein the second guide-pin-holder component may have at least one adaptor hole for a guide pin, and at least one mounting hole configured to attach the insertion head to the plier-like device securely.

In some aspects, the techniques described herein relate to the second guide-pin-holder component, which may be a cube.

In some aspects, the techniques described herein relate to the second guide-pin-holder component that may have a rectangular cuboid structure.

In some aspects, the techniques described herein relate to the second guide-pin-holder component that may be aligned flushed with an upper-insertion-head-cavity-wall of the insertion-head-cavity, a lower-insertion-head-cavity-wall of the insertion-head-cavity, and a semi-circular-back-insertion-head-cavity-wall of the insertion-head-cavity.

In some aspects, the techniques described herein relate to the second guide-pin-holder component that may be raised from an upper-insertion-head-cavity-wall of the insertion-head-cavity, lower-insertion-head-cavity-wall of the insertion-head-cavity, and semi-circular-back-insertion-head-cavity-wall of the insertion-head-cavity.

In some aspects, the techniques described herein relate to the second component guide-pin-holder that may be U-shaped.

In some aspects, the techniques described herein relate to the second component guide-pin-holder component, which may be 17 mm wide, 17 to 19.5 mm long, with a depth of 17.5 to 18.5 mm.

In some aspects, the techniques described herein relate to the first component that may be 15.4 to 22.0 mm wide, 15.75 to 38.2 mm long, and 11 to 19.5 mm tall.

In some aspects, the techniques described herein relate to the method of use of the battery connector separation apparatus may include two insertion heads, one cap, one insertion chamber, and at least one guide-pin, wherein the two insertion heads may be flushed aligned and parallel to each other, and the cap is horizontally aligned to the two insertion heads configured to form the one insertion chamber, wherein the apparatus may be configured to mount onto a plier-like device, and ma include the steps: (i) remove the cap on the top of the insertion chamber, (ii) ensure that there may be no gaps between the insertion heads by moving the lower ends of the plier-like device handles, (iii) place a battery connector with a shoulder in the insertion chamber, (iv) the battery connector with the shoulder is inserted into the wider insertion chamber with a click, (v) ensuring the shoulder of the battery connector is placed flush against the side of the insertion heads, (vi) place the cap onto the top of the insertion heads by sliding the cap onto the ends of the insertion heads the one and only way allowed by the design, (vii) give a light squeeze to the lower ends of the plier-like device handles to seat the teeth of the insertion head into the connector-grooves of the short side of the connector, (viii) squeeze the lower ends of the plier-like device handles together completely and until the connector separates, (ix) release the lower ends of the plier-like device handles and remove the shoulder side of the battery connector, (x) the battery connector will now come out of the side of the insertion head, (xi) slide the cap off the insertion heads' end and remove the connector's other end, and (xii) ensure the insertion heads may be together, slide the cap back onto the ends of the insertion heads, and store the apparatus for future use.

### BRIEF DESCRIPTION OF DRAWINGS

FIG. 1. Top isometric view of the apparatus mounted onto a plier-like device.

FIG. 2. Front and back views of the apparatus mounted onto a plier-like device.

FIG. 2A is the top view.

FIG. 2B is the bottom of the apparatus mounted onto a plier-like device.

FIG. 3. Top and bottom views of the apparatus mounted onto a plier-like device.

FIG. 3A. is the left of the apparatus mounted onto a plier.

FIG. 3B. is the right of the apparatus mounted onto a plier-like device.

FIG. 4. End views of the apparatus mounted onto a plier-like device.

FIG. 4A is the bottom view of the apparatus mounted onto a plier device.

FIG. 4B is the top view of the apparatus mounted onto a plier device.

FIG. 5. Isometric view of the apparatus mounted onto a plier-like device.

FIG. 5A is the top view.

FIG. 5B is the side view.

FIG. 5C is the bottom view.

FIG. 6. Isometric views of the apparatus mounted onto a plier-like device.

FIG. 6A. Shows the insertion heads without the battery connector

FIG. 6B. Shows the apparatus without the cap but with the battery connector inserted in the insertion chamber.

FIG. 6C. Shows a battery connector with its shoulder.

FIG. 7. Isometric views of the apparatus with battery connector mounted on a plier-like device.

FIG. 7A. shows a battery connector in the insertion chamber with the cap covering the top.

FIG. 7B. Shows the insertion chambers with the battery connector and cap on the top.

FIG. 8. Isometric views of the apparatus showing the removal of the battery connector.

FIG. 8A. Shows the apparatus in the open position with one side of the battery connector removed.

FIG. 8B. Shows the apparatus in the open position with one side of the connector separated and removed.

FIG. 8C. Shows the apparatus in the open position with both sides of the battery connector.

FIG. 9. Top and side views of plier-like devices with dimensions.

FIG. 9A Top views of plier-like devices with dimensions.

FIG. 9B Side views of plier-like devices with dimensions.

FIG. 10. Orthographic and isometric views of the cap.

FIG. 10A is a bottom-side isometric view of the cap.

FIG. 10B is a bottom-side view.

FIG. 10C is a front-end view.

FIG. 10D is a top-side isometric view.

FIG. 10E is a side view.

FIG. 11. Orthographic and isometric views of the insertion head with dimensions for use with flat tab, typically black in color, connectors.

FIG. 11A. Orthographic and isometric top views of the insertion head with dimensions.

FIG. 11B. Orthographic and isometric side views of the insertion head with dimensions.

FIG. 11C. Orthographic and isometric side views of the insertion head with dimensions.

FIG. 11D. Orthographic and isometric top views of the insertion head.

FIG. 11E. Orthographic and isometric side views of the insertion head.

FIG. 12. Orthographic and isometric views of the insertion head with dimensions for use with 6.5 mm diameter, typically pale green in color, connectors.

FIG. 12A. Orthographic and isometric top views of the insertion head with dimensions.

FIG. 12B. Orthographic and isometric side views of the insertion head with dimensions.

FIG. 12C. Orthographic and isometric side views of the insertion head with dimensions.

FIG. 12D. Orthographic and isometric top views of the insertion head.

FIG. 12E. Orthographic and isometric side views of the insertion head.

FIG. 13. Orthographic and isometric views of the insertion head with dimensions for use with 8.0 mm diameter, typically black in color, connectors.

FIG. 13A. Orthographic and isometric top views of the insertion head with dimensions.

FIG. 13B. Orthographic and isometric top views of the insertion head with dimensions.

FIG. 13C. Orthographic and isometric front views of the insertion head with dimensions.

FIG. 13D. Orthographic and isometric views of the insertion head with dimensions.

FIG. 13E. Orthographic and isometric side views of the insertion head.

FIG. 14. Orthographic and isometric views of the insertion heads with dimensions for use with 8.0 mm diameter, typically black in color, connectors.

FIG. 14A. Orthographic and isometric top views of the insertion heads with dimensions.

FIG. 14B. Orthographic and isometric top views of the insertion heads with dimensions.

FIG. 14C. Orthographic and isometric backviews of the insertion heads with dimensions.

FIG. 14D. Orthographic and isometric side views of the insertion heads with dimensions.

FIG. E. Orthographic and isometric top views of the insertion heads.

FIG. 15. Orthographic and isometric views of the insertion heads with dimensions for use with 5.0 mm diameter, typically blue in color, connectors.

FIG. 15A. Orthographic and isometric top views of the insertion heads with dimensions.

FIG. 15B. Orthographic and isometric front views of the insertion heads with dimensions.

FIG. 15C. Orthographic and isometric side views of the insertion heads with dimensions.

FIG. 15D. Orthographic and isometric top views of the insertion heads.

FIG. 16. Orthographic and isometric views of the insertion heads with dimensions for use with 5.0 mm diameter, typically blue in color, and 5.0 mm diameter, typically orange in color, combination style connectors.

FIG. 16A. Orthographic and isometric top views of the insertion heads with dimensions.

FIG. 16B. Orthographic and isometric front views of the insertion heads with dimensions.

FIG. 16C. Orthographic and isometric side views of the insertion heads with dimensions.

FIG. 16D. Orthographic and isometric top views of the insertion heads.

FIG. 16E. Orthographic and isometric side views of the insertion heads.

FIG. 17. Orthographic and isometric views of the insertion heads with dimensions for use with 5.0 mm diameter, typically orange in color, connectors.

FIG. 17A. Orthographic and isometric top views of the insertion heads with dimensions.

FIG. 17B. Orthographic and isometric front views of the insertion heads with dimensions.

FIG. 17C. Orthographic and isometric side views of the insertion heads with dimensions.

FIG. 17D. Orthographic and isometric top views of the insertion.

FIG. 18. Orthographic and isometric views of the insertion heads with dimensions for use with 4.0 mm diameter, typically pale green in color, connectors.

FIG. 18A. Orthographic and isometric top views of the insertion heads with dimensions.

FIG. 18B. Orthographic and isometric front views of the insertion heads with dimensions.

FIG. 18C. Orthographic and isometric side views of the insertion heads with dimensions.

FIG. 18D. Orthographic and isometric top views of the insertion heads

FIG. 18E. Orthographic and isometric side views of the insertion heads.

FIG. 19. Orthographic and isometric views of the insertion heads with dimensions for use with normal and anti-spark 4.6 mm diameter, typically yellow in color, connectors.

FIG. 19A. Orthographic and isometric top views of the insertion heads with dimensions.

FIG. 19B. Orthographic and isometric front views of the insertion heads with dimensions.

FIG. 19C. Orthographic and isometric side views of the insertion heads with dimensions.

FIG. 19D. Orthographic and isometric top views of the insertion heads.

FIG. 20. Orthographic and isometric views of the insertion heads with dimensions for use with 3.0 mm diameter, typically blue in color, connectors.

FIG. 20A. Orthographic and isometric top views of the insertion heads with dimensions.

FIG. 20B. Orthographic and isometric front views of the insertion heads with dimensions.

FIG. 20C. Orthographic and isometric side views of the insertion heads with dimensions.

FIG. 20D Orthographic and isometric top views of the insertion heads.

FIG. 21. Orthographic and isometric views of the insertion heads with dimensions for use with 3.0 mm diameter, typically orange in color, connectors.

FIG. 21A. Orthographic and isometric top views of the insertion heads with dimensions

FIG. 21B. Orthographic and isometric front views of the insertion heads with dimensions.

FIG. 21C Orthographic and isometric side views of the insertion heads with dimensions.

FIG. 21D. Orthographic and isometric top views of the insertion heads.

FIG. 22. Orthographic and isometric views of the insertion heads with dimensions and for use with anti-spark 3.6 mm diameter, typically yellow in color, connectors.

FIG. 22A. Orthographic and isometric top views of the insertion heads with dimensions.

FIG. 22B. Orthographic and isometric front views of the insertion heads with dimensions.

FIG. 22C. Orthographic and isometric side views of the insertion heads with dimensions.

FIG. 22D. Orthographic and isometric top views of the insertion heads.

FIG. 23. Orthographic and isometric views of the insertion head with dimensions for use with anti-spark T-Plug, typically red in color, style connectors.

FIG. 23A. Orthographic and isometric top views of the insertion heads with dimensions.

FIG. 23B. Orthographic and isometric front views of the insertion heads with dimensions.

FIG. 23C. Orthographic and isometric side views of the insertion heads with dimensions.

FIG. 23D. Orthographic and isometric top views of the insertion heads.

FIG. 24. Method of use for the battery connector separation apparatus.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments of the present disclosure. It will be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

In some aspects, the techniques described herein relate to separate electrical connectors, specifically battery connectors, for remote-controlled vehicle batteries. The electrical connector feature may be essential for recharging batteries in remote-controlled vehicles. This apparatus makes separating battery connectors quick and easy and may be used by one hand. The battery separator apparatus may be made of several parts, including two insertion heads, one cap, one insertion chamber, and at least one guide-pin (for example, 2, 3, 4, 5, 6, 7, 8 etc.), wherein the two insertion heads may be flushed aligned and parallel to each other, and the cap may be horizontally aligned to the two insertion heads configured to form the one insertion chamber, and wherein the apparatus may be configured to mount onto a plier-like device.

In some aspects, the techniques described herein relate to a guide pin that may be used to keep the moveable tool head aligned and prevent it from pivoting.

In some aspects, the techniques described herein relate to a plier-like-device, wherein the plier-like device further may include two handles, one pivot point, and two jaws, wherein each handle may have an upper-handle-end and lower-handle-end, wherein each jaw may have an upper-jaw-end and a lower-jaw-end, where two lower-end of the two jaws and the upper-ends of the two handles may be connected together at the pivot point, and wherein the one compression spring may be placed between the two upped-handle-ends and below the pivot point.

In some aspects, the techniques described herein relate to a plier-like-device, wherein the jaws may include at least one mounting bolt (for example, 1, 2, 3, 4, 5, 6, 7, 8, etc.) on each jaw configured to mount securely by the mounting bolts, wherein the mounting bolts may be M4×10.

In some aspects, the techniques described herein relate to a plier-like device, wherein the compression spring may be 12 mm×30 mm.

In some aspects, the techniques described herein relate to an apparatus cap, wherein the one cap may include a rectangular cuboid, wherein the rectangular cuboid may have one top-cap-surface, one bottom-cap-surface, one back-cap-wall, one right-cap-wall, one left-cap-wall, and a front-cap-surface, wherein the top-cap-surface may be smooth-flat, the bottom-cap-surface may have two cavities divided by a middle-cap-wall, wherein the front-cap-surface may have two openings, wherein each opening extends into each cavity. Each of these walls may have an inner and an outer wall, which may or may not be identical.

In some aspects, the techniques described herein relate to an apparatus top cap surface, wherein the surface may be serrated, not flat, uneven, rough, rugged, abrupt, precipitous, unpolished, harsh, blunt, coarse, irregular, cavities, etc. or any combination thereof.

In some aspects, the techniques described herein relate to an apparatus bottom cap surface, wherein the surface may contain 1, 2, 3, 4, 5, 6, 7, 8, 9, etc., or any combination of cavity numbers. The cavities may be identical, non-identical, mirror images of each other, non-mirror images, etc., or any combination thereof.

In some aspects, the techniques described herein relate to an apparatus bottom cap surface, wherein the bottom surface may have 1, 2, 3, 4, 5, 6, 7, 8, 9, 10, etc., or any combination thereof walls. The bottom surface may have 1, 2, 3, 4, 5, 6, 7, 8, etc., or any combination of openings.

In some aspects, the techniques described herein relate to an apparatus, wherein a top cap surface, a back-cap-wall, a right-cap-wall, a left-cap-wall, and a front-cap-surface, each may have an outer side and an inner side, wherein the outer sides of right-cap-wall, back-cap-wall, left-cap-wall outer walls may be flat, and wherein the outer sides of left/right-cap-wall may have a tethering tool attached.

In some aspects, the techniques described herein relate to an apparatus top cap walls, wherein the wall/s may be serrated, ridged, not flat, uneven, rough, rugged, abrupt, precipitous, unpolished, harsh, blunt, coarse, irregular, cavities, etc. or any combination thereof.

In some aspects, the techniques described herein relate to an apparatus cap, wherein one, two, or more cap cavities may be parallel to each other, wherein each cavity may be U-shaped and cylindrical shaped. The U-shaped may be smooth, cornered, or both.

In some aspects, the techniques described herein relate to an apparatus wherein each cavity may be 27.4 mm wide, 32.5 mm long, and 12.25 mm deep.

In some aspects, the techniques described herein relate to an apparatus wherein the bottom-cap-surface two cavities fit into one, two, or more insertion heads (for example, 1, 2, 3, 4, 5, 6, 7, 8, etc., or any combination of insertion heads).

In some aspects, the techniques described herein relate to an insertion-chamber, wherein the insertion chamber may include an insertion-chamber-right-wall, an insertion-chamber-left-wall, an insertion-chamber-bottom-wall, and an insertion-chamber-top-wall. The insertion-chamber-right-wall, insertion-chamber-left-wall, and insertion-chamber-bottom-wall may be formed by the insertion heads, and the insertion-chamber-top-wall may be formed by the cap.

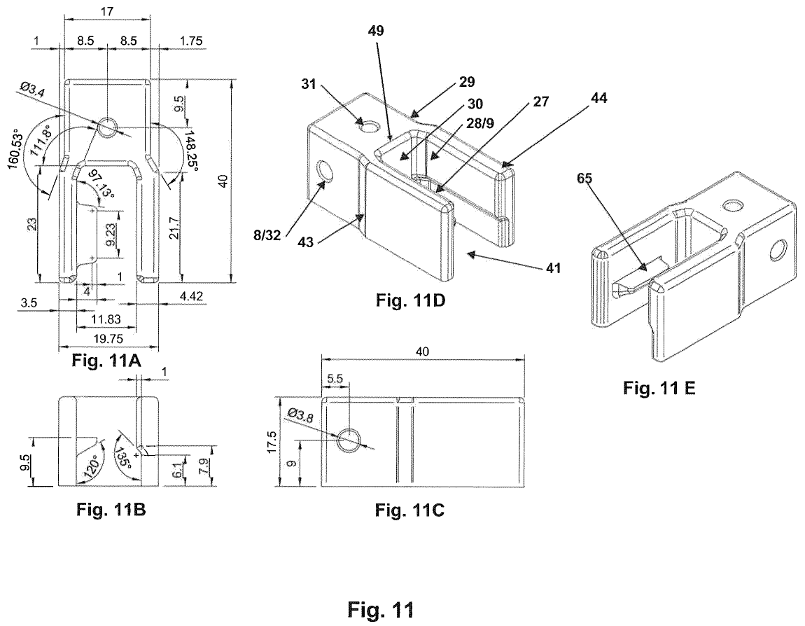

In some aspects, the techniques described herein relate to an apparatus wherein the insertion head may be similar/identical in shape, structure, mirrored image, etc., or any combination thereof. The structural shapes (see FIGS. 11 to 23) may allow for the interchangeability and replacement of both insertion heads in the apparatus. Due to this interchangeability of the insertion heads, the apparatus may be customized for a variety of electrical or battery connectors. One or more of the insertion heads may be used for a specific connector.

In some aspects, the techniques described herein relate to an insertion head, wherein the insertion head may include at least two components, for example, 2, 3, 4, 5, 6, 7, 8, 9, 10, etc., or any combination thereof.

In some aspects, the techniques described herein relate to an insertion head; the insertion head may include at least two components, wherein the first component may be an insertion-head-cavity configured to form 10, 20, 25, 30, 40, 50, 60, 70, 75, 80, or 90 percent of one insertion chamber, and wherein a second component may be a guide-pin-holder.

In some aspects, the techniques described herein relate to the second component, wherein the second component may be a rectangular cuboid.

In some aspects, the techniques described herein relate to the first component, wherein the first component may further compromise a U-shaped cylindrical cavity may include an upper-insertion-head-cavity-wall, a lower-insertion-head-cavity-wall, a back-insertion-head-cavity-wall, and two insertion-head-side-openings and one insertion-head-font-opening, and wherein the upper-insertion-head-cavity-wall and the lower-insertion-head-cavity-wall may be flat.

In some aspects, the techniques described herein relate to the back-insertion-head-cavity-wall, wherein the wall may be semi-circular, linear, square, rectangular, etc.

In some aspects, the techniques described herein relate to the second guide-pin-holder, wherein the second guide-pin-holder component may be attached to the back-insertion-cavity-wall, wherein the back-insertion-head-cavity-may be semi-circular, linear, square, rectangular, etc.

In some aspects, the techniques described herein relate to the second guide-pin-holder, wherein the second guide-pin-holder component may have at least one adaptor hole (for example, 1, 2, 3, 4, 5, 6, 7, 8,9, 10, etc.) for the guide pin, and at least one mounting hole (for example, 1, 2, 3, 4, 5, 6, 7, 8,9, 10, etc.) and may be configured to attach the insertion head to the plier-like device securely.

In some aspects, the techniques described herein relate to the insertion head, wherein the second guide-pin-holder component may be a cube.

In some aspects, the techniques described herein relate to an insertion head, wherein the second guide-pin-holder component may be a rectangular cuboid.

In some aspects, the techniques described herein relate to an insertion head wherein the second guide-pin-holder component may be aligned evenly or flushed with the upper-insertion-head-cavity-wall, the lower-insertion-head-cavity-wall, and the back-insertion-head-cavity-wall/semi-circular-back-insertion-head-cavity-wall.

In some aspects, the techniques described herein relate to an insertion head, wherein the second guide-pin-holder component may be raised from the upper-insertion-head-cavity-wall, lower-insertion-head-cavity-wall, and back-insertion-head-cavity-wall/semi-circular-back-insertion-head-cavity-wall.

In some aspects, the techniques described herein relate to an insertion head, wherein the second guide-pin-holder component may be U-shaped, wherein the U-shape may be semi-circular, square, or rectangular.

In some aspects, the techniques described herein relate to an insertion head, wherein the second guide-pin-holder component may be up to 25 mm, for example, 15, 16, 17, 18, 19, 20, 21, 22, 23, 24 mm wide, from 10 to 25 mm long, for example, 11, 12, 13, 14, 15, 16, 17, 18, 19, 19.1, 19.2, 19.3, 19.4, 19.5, 19.6, 19.7, 19.8, 19.9, 20 mm long, with a depth of 10 to 25 mm, for example, 11, 12, 13, 14, 15, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, or18.5 mm. The dimensions may be any combination of these values and/or those shown in the figures.

In some aspects, the techniques described herein relate to an insertion head, wherein the first component may be 10 to 25 mm, for example, 11, 12, 13, 14, 15, 15.1, 15.2, 15.3, 15.4, 15.5, 15.6, 15.7, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.5, 21, 21.1, 21.2, 21.3, 21.4, 21.5, 21.6, 21.7, 21.8, 21.9, 22.0, 22, 23, 24, 25, mm wide, 10 to 40 mm, for example, 11, 12, 13, 14, 15, 15.1, 15.2, 15.3, 15.4, 15.5, 15.6, 15.7, 15.75, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 21, 22, 23, 24, 25, 26, 27, 28, 29, 30, 31, 32, 33, 34, 35, 36, 37, 37.5, 37.6, 37.7, 37.8, 37.9, 38, 38.1, 38.2, 38.3, 38.4, 38.5, 38.6, 38.7, 38.8, 38.9, 40 mm long, and 11, 12, 13, 14, 15, 15.1, 15.2, 15.3, 15.4, 15.5, 15.6, 15.7, 15.75, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 21, 22, 23, 24, 25, 26, 27, 28, 29, 30, 31, 32, 33, 34, 35, 36, 37, 37.5, 37.6, 37.7, 37.8, 37.9, 38, 38.1, 38.2, 38.3, 38.4, 38.5, 38.6, 38.7, 38.8, 38.9, 40 mm tall. The dimensions may be any combination of these values and/or those shown in the figures.

In some aspects, the techniques described herein relate to an apparatus, wherein the insertion chamber may be 5 to 25, for example, 5, 6, 7, 8, 8.1, 8.2, 8.3, 8.4, 8.5, 8.6, 8.7, 8.8, 8.9, 9, 10, 11, 12, 13, 14, 15, 15.1, 15.2, 15.3, 15.4, 15.5, 15.6, 15.7, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.5, 21, 21.1, 21.2, 21.3, 21.4, 21.5, 21.6, 21.7, 21.8, 21.9, 22.0, 22, 23, 24, 25 mm wide; 10 to 25 mm, for example, 11, 12, 13, 14, 15, 15.1, 15.2, 15.3, 15.4, 15.5, 15.6, 15.7, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.5, 21, 21.1, 21.2, 21.3, 21.4, 21.5, 21.6, 21.7, 21.8, 21.9, 22.0, 22, 23, 24, 25, 26, 27, 28, 29, 30, 31, 32, 33, 34, 35, 36, 37, 37.5, 37.6, 37.7, 37.8, 37.9, 38, 38.1, 38.2, 38.3, 38.4, 38.5, 38.6, 38.7, 38.8, 38.9, 40 mm long, and 10 to 25 mm, for example, 11, 12, 13, 14, 15, 15.1, 15.2, 15.3, 15.4, 15.5, 15.6, 15.7, 15.8, 15.9, 16, 17, 17.1, 17.2, 17.3, 17.4, 17.5, 17.6, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, 20, 20.5, 21, 21.1, 21.2, 21.3, 21.4, 21.5, 21.6, 21.7, 21.8, 21.9, 22.0, 22, 23, 24, 25, mm deep. The dimensions may be any combination of these values and/or those shown in the figures.

In some aspects, the techniques described herein relate to an apparatus wherein the guide pin may be a 3 mm×55 mm screw pin. The guide pin may be a 3 to 4 mm×50 to 60 mm screw pin.

In some aspects, the techniques described herein relate to an apparatus where the insertion heads, cap, and insertion chamber may be made of a durable, non-conductive, and heat-resistant plastic such as ABS, ASA, PETG, PCTG, PA6, PA12, Polycarbonate, or similar plastics, with or without non-conductive reinforcing materials, such as glass fibers, wood, or natural man-made materials, or any combination thereof, wherein the guide pin and compression spring may be made of metals such as steel, hardened steel, or spring steel.

In some aspects, the techniques described herein relate to the guide pin that may be made of a drive head and one smooth cylinder with the drive head connected at one end of the cylinder. There may be a coarse thread for a short distance from the drive head, but the guide pin may be a smooth cylinder for the remaining length. The threads may hold the guide pin in place in one of the insertion heads.

In some aspects, the techniques described herein relate to an apparatus that may be used with the following connector types: Amass Dean's, EC2, EC3, EC5, IC2, IC3, EC5, IC2/EC2 Combo, IC3/EC3 Combo, IC5/EC5 Combo, XT60H, XT90, XT90H, TRX (Traxxas), Castle 4.0 mm, Castle 6.5 mm, & QS8, etc. or any combination thereof.

In some aspects, the techniques described herein relate to an apparatus may be used with the connector with one or more features such as flat tab, typically black in color; 8.0 mm diameter, typically black in color; 6.5 mm diameter, typically pale green in color; 4.0 mm diameter, typically pale green in color; 5.0 mm diameter, typically blue in color; 3.0 mm diameter, typically blue in color; 5.0 mm diameter, typically orange in color; 3.0 mm diameter, typically orange in color; 5.0 mm diameter, typically blue in color, and 5.0 mm diameter, typically orange in color, used in combination; anti-spark 4.6 mm diameter, typically yellow in color; anti-spark 3.6 mm diameter, typically yellow in color; anti-spark T-Plug, typically red in color, etc. or any combination thereof.

In some aspects, the techniques described herein relate to the method of use of the battery separation apparatus that may include two insertion heads, one cap, one insertion chamber, and at least one guide-pin, wherein the two insertion heads may be flushed aligned and parallel to each other, and the cap may be horizontally aligned to the two insertion heads configured to form the one insertion chamber, wherein the apparatus may be configured to mount onto a plier-like device, and may include the steps: (i) remove the cap on the top of the insertion heads, (ii) ensure that there may have no gaps between the insertion heads by moving the lower ends of the plier-like device handles, (iii) place a battery connector with a shoulder in the insertion chamber, (iv) the battery connector with the shoulder [19A] may be inserted into the wider insertion chamber with a click, (v) ensuring the shoulder of the battery connector may be placed flush against the side of the insertion heads, (vi) place the cap onto the top of the insertion heads by sliding the cap onto the ends of the insertion heads the only, correct way allowed by the design, (vii) give a light squeeze to the lower ends of the plier-like device handles to seat the teeth of the insertion head into the connector-grooves of the short side of the connector, (viii) squeeze the lower ends of the plier-like device handles together completely and until the connector separates, (ix) release the lower ends of the plier-like device handles and remove the shoulder side of the battery connector, (x) the battery connector will now come out of the side of the insertion head, (xi) slide the cap off the insertion heads' end and remove the connector's other end, and (xii) ensure the insertion heads may be together, slide the cap back onto the ends of the insertion heads, and store the apparatus for future use.

The apparatus may be made of one or more components such as two handles, two insertion heads, one head cap with tether, which may or may not be required, four M4×10 mm machine screws, one M5×16 mm machine screw, one 12×30 mm compression spring, and one or two 3×55 mm guide pins.

The apparatus converts any typical piler with two handles into a battery connector separator by adding the pivoting insertion head/s with or without a head cap and guide pin/s.

The apparatus may be operated by squeezing the handles, which opens the apparatus's heads (the insertion-heads) and may allow pivot in the ends of the plier-like devices to open, but they may be constrained with the guide pin(s).

The apparatus may be used with any conventional plier-like devices; the apparatus may have interchangeable insertion heads that may be identical, non-identical, mirrored images, non-mirrored images, etc., or any combination thereof. Each insertion head may be designed to fit different battery connectors used in remote-controlled vehicles; thus, the apparatus may be customizable for a variety of battery/electrical connections. The insertion heads pivot on the ends of the handles and may be constrained by a guide pin, allowing the apparatus to perform its function. This arrangement may allow the insertion heads to be parallel to each other and separate the connector parts linearly and horizontally to the insertion head and the plier-like device handles.

In some aspects, the techniques described herein relate to the method of use of a battery separator apparatus, which may include two insertion heads, one cap, one insertion chamber, and at least one guide-pin, wherein the two insertion heads may be flushed aligned and parallel to each other. The cap may be horizontally aligned to the two insertion heads configured to form the one insertion chamber, wherein the apparatus may be configured to mount onto a plier-like device with two handles with lower and upper-handle-ends, and the method may include the steps below; these steps may or may not be the order provided and may have additional steps or may be without one or more steps. Steps may be: (i) removing the cap from top of the insertion chamber, (ii) ensuring that there are no gaps between the insertion heads by moving the plier-like device handles at a lower end, (iii) placing a battery connector with a shoulder in the insertion chamber, (iv) inserting into the insertion chamber at a wider angle and clicking with a click the battery connector with a shoulder, (v) ensuring the shoulder of the battery connector is placed flush against the side of the insertion heads, (vi) placing the cap onto the top of the insertion chamber by sliding the cap in a correct way, which may or may not be from one side (vii) giving a light squeeze to the lower ends of the plier-like device handles to seating the insertion-head teeth into the short side of the connector, (viii) squeezing the lower ends of the plier-like device handles together completely and until the connector separates, (ix) releasing the lower ends of the plier-like device handles and removing the shoulder side of the battery connector, (x) the battery connector coming out of the side of the insertion head, (xi) sliding the cap off the insertion heads' end and removing the connector's other end, and (xii) ensure the insertion heads are together, slide the cap back onto the ends of the insertion heads, and store the apparatus for future use.

### DETAILED DESCRIPTION OF THE FIGURES

Dimensions in all the figures units are in millimeters; all fillets are 1.0 unless noted; all chamfers are 0.4×45 mm unless stated otherwise, and all dimensions errors are +/−0.05.

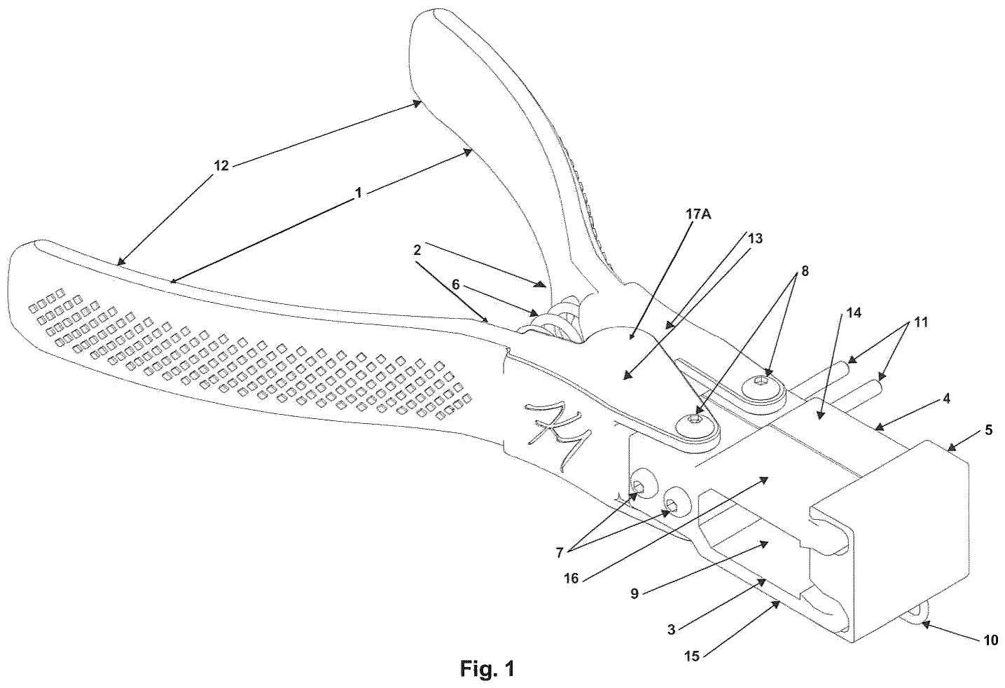

FIG. 1. Top isometric view of the apparatus mounted onto a plier-like device. The apparatus is made of at least two insertion heads [3] and [4] forming an insertion chamber [9] for inserting the battery connector (not shown herein). The insertion heads comprise two components; the first component forms the insertion chamber or part thereof, such as 25%, 50%, 75%, 100%, etc., or any combination thereof. The second component contains the guide pin/s. This second component may have at least one guide-pin-hole (in this example, two) through which at least one (in this example, two, one for each guide-pin-hole) guide pins are placed [7] and [11]. The guide pin has a structure similar to a screw, with one end of the guide pin being a cylindrical, smooth rod to allow movement of the second insertion head along its length [11]. The guide pin also has a coarse-threaded section at or near the drive head but is smooth for the remaining length (not shown here). The threads fasten the guide pin into one insertion head [7]. The guide pin is 3×55 mm. The apparatus also has a cap [5] that can be tethered by a tethering flexible thread or wire [10].

The apparatus is attached to a plier-like device with handles having two upper ends of the handles [2] and two lower ends of the handle [1]. The apparatus is mounted on the plier-like device using two or more (in this example, four mounting bolts, but two of them are not shown herein) [8] on the top-end of the plier-like device's jaws [13]. The mounting bolts may be M4×10 mm. The upper plier-like device's handles [2] are joined at a pivot point [17A] by a pivot bolt (not shown herein) [17] and are separated by a compression spring [6] placed between the upper end of two plier-like device handles [2]. As the two handles are pressed together at the lower end [1], the pivoting action created around the pivot point [17A] and pivot bolt [17] will separate the two insertion heads, causing the battery connector placed within the insertion chamber to separate as the two insertion heads separate. When the handles are released, the compression spring returns the handles and insertion heads to their starting or initial position. The compression spring can be 12 mm×30-50 mm; each guide pin is 3 mm×55-65 mm; the mounting bolts are M4×10 mm bolts; and the pivot bolt is M5×16 mm.

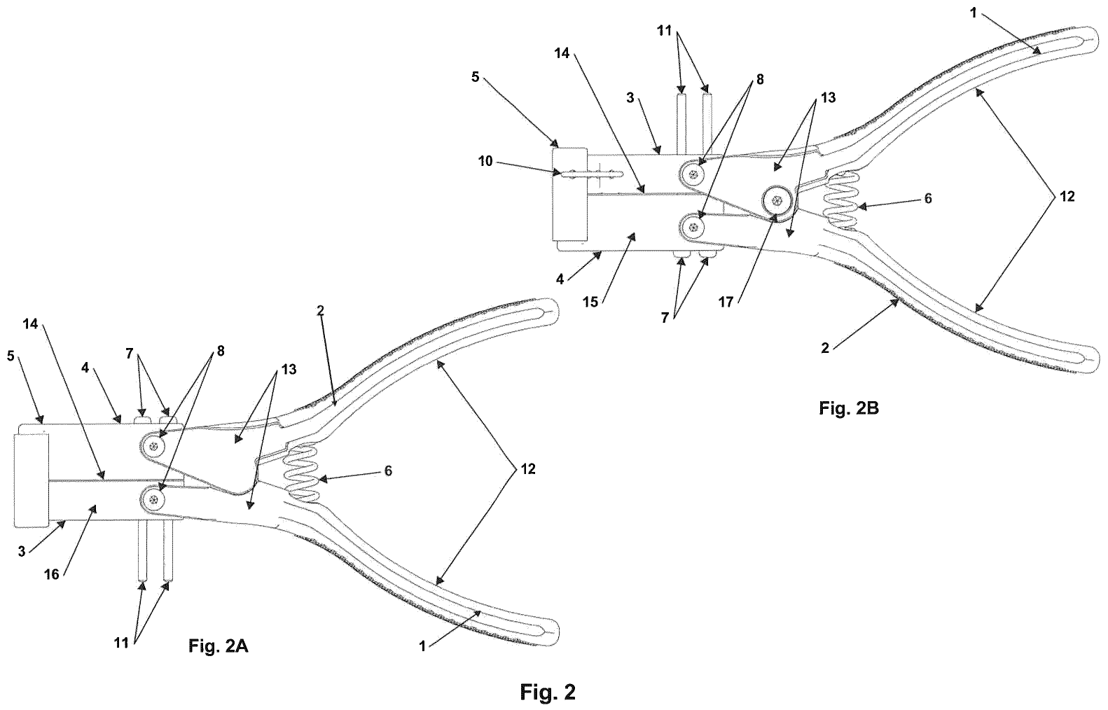

FIG. 2. Front and back views of the apparatus mounted onto a plier-like device. FIG. 2A is the top, and FIG. 2B is the bottom of the apparatus mounted onto a plier-like device. The apparatus is made of at least two insertion heads [3] and [4] forming an insertion chamber (not shown herein) for inserting the battery connector (not shown herein). The insertion heads also have two guide-pin-holes through which the two guide pins are placed [7] and [11]. The guide pin is structurally similar to a screw but with a short-threaded section near one end that fastens the guide pin into one insertion head [7]; the other end of the guide pin is a cylindrical, smooth rod to allow movement of the second insertion head along its length [11]. The apparatus also has a cap [5] that can be tethered by a tethering tool, which can be flexible thread or wire [10], which is visible in the bottom view. Additionally, the plier-like device [12] has two handles with upper [2] and lower [1] ends, one pivot point with a single pivot-point screw [17], which is clearly visible in the bottom view, and two jaws [13] with two mounting bolts on each jaw [8]. The apparatus is mounted securely by the mounting bolts [8]. In other embodiments may have different numbers of pivot-point screw/s (for example, two or more), mounting bolts (for example, 4, 6, 8, etc.), insertion heads (for example, 2, 3, 4, 5, 6, etc.) and/or guide-pin-holes and guide-pins (for examine 1, 2, 3, 4, 5, 6, 7, 8, 9, 10, etc.).

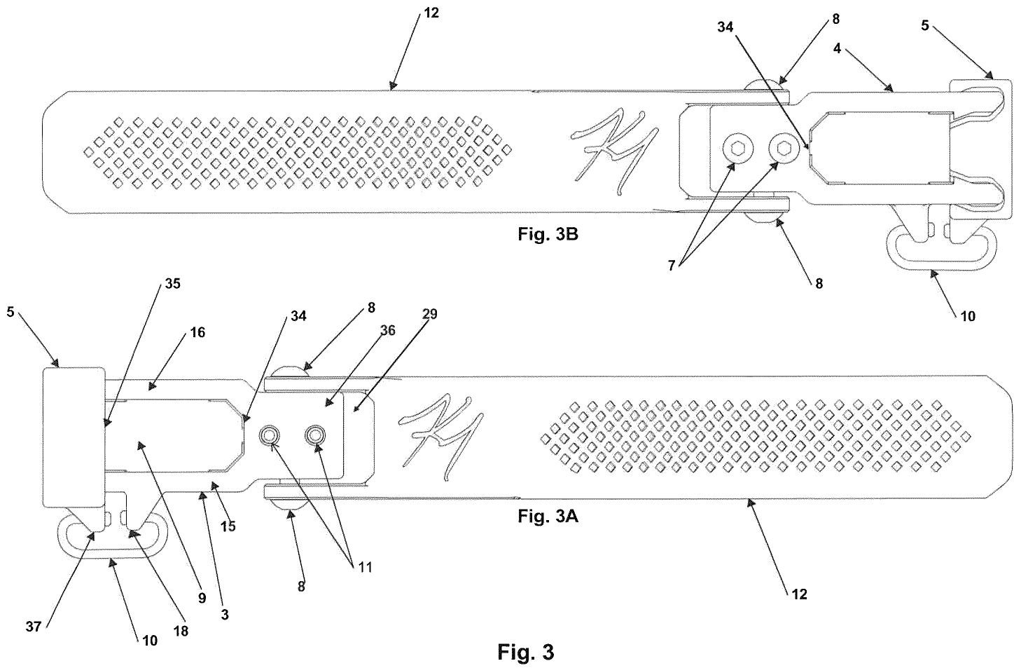

FIG. 3. Top and bottom views of the apparatus mounted onto a plier-like device. FIG. 3A is the left, and FIG. 3B is the right of the apparatus mounted onto a plier-like device. The apparatus is made of at least two insertion heads [3] and [4] forming an insertion chamber [9] for inserting the battery connector (not shown herein). The insertion heads also have two guide-pin-holes through which the two guide pins are placed [7] and [11]. The two insertion heads are aligned parallel and aligned flush to each other, so in this view, only one insertion head is visible in each figure. The two insertion heads and the one cap are configured to form one insertion chamber [9] made by a chamber-right-wall [15/16], a chamber-left-wall [16/15], a chamber-bottom-wall [34], and a chamber-top-wall [35]. The chamber-right-wall, chamber-left-wall [15, 16], and chamber-bottom-wall [34] are made of the insertion heads, and the chamber-top-wall [35] is made of the cap. The guide pins are located within the middle part of the chamber-bottom wall [36], referred to as the guide-pin-holder [29]. The apparatus has a tethering tool [37], [10], and [18]. The tethering tool [37] is made of a tethering attachment device [18] and a flexible tethering thread [10]. The tethering attachment device has at least two parts: a tethering attachment part [18 and 37] and a tethering thread [10]. The tethering attachment is a protuberance with a hole in this example, one on the insertion head [18] and the other on the cap [37]. The tethering tool tethers the cap to the insertion head [3] (one or both) via a tethering thread [10] attached to the tethering attachment on the cap and on the insertion head [18].

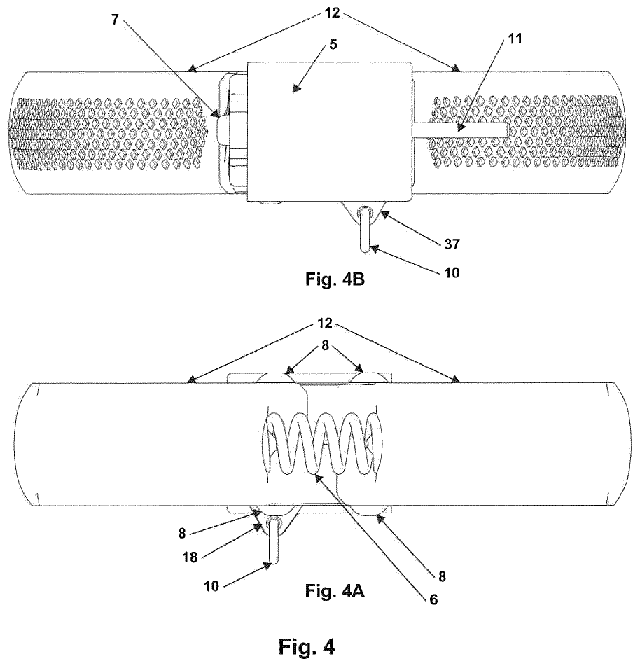

FIG. 4. End views of the apparatus mounted onto a plier-like device.

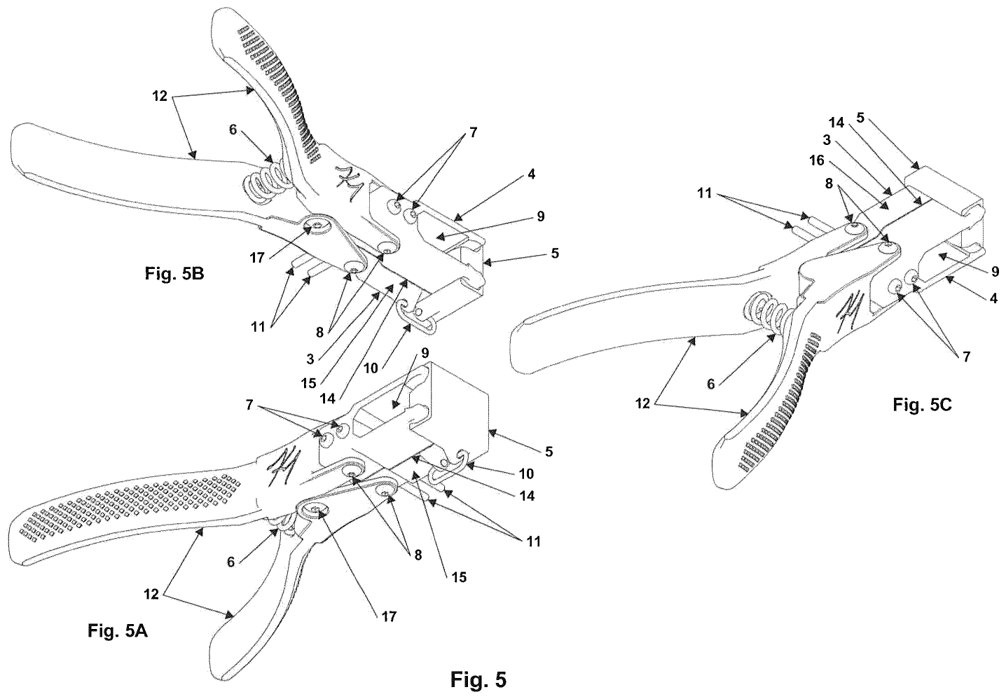

FIG. 5. Isometric view of the apparatus mounted onto a plier-like device.

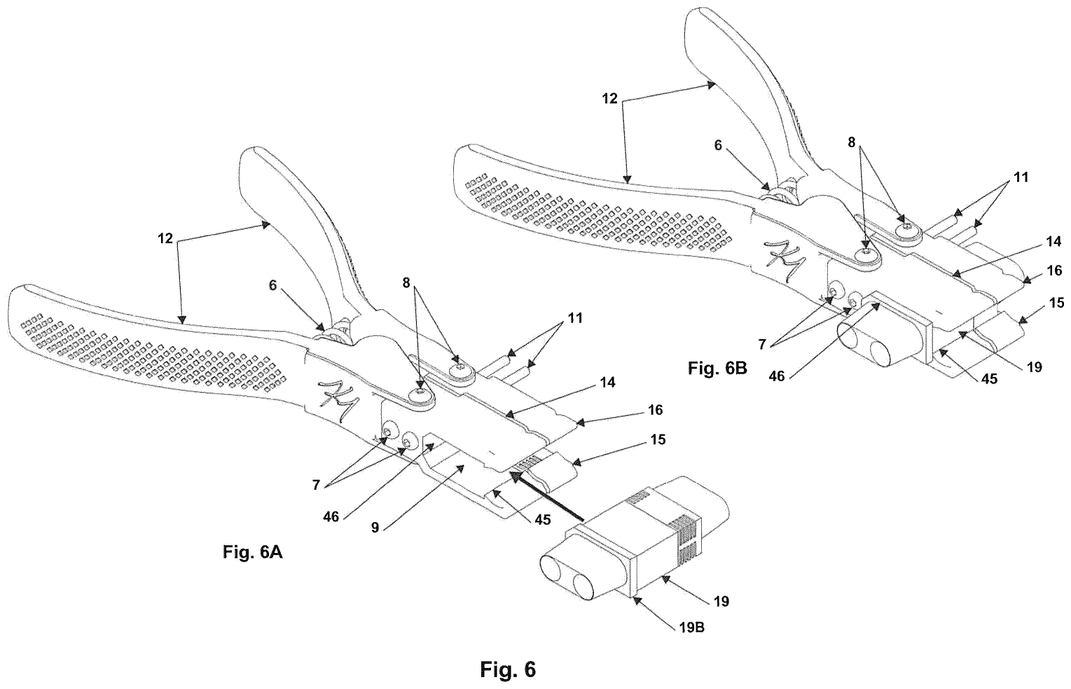

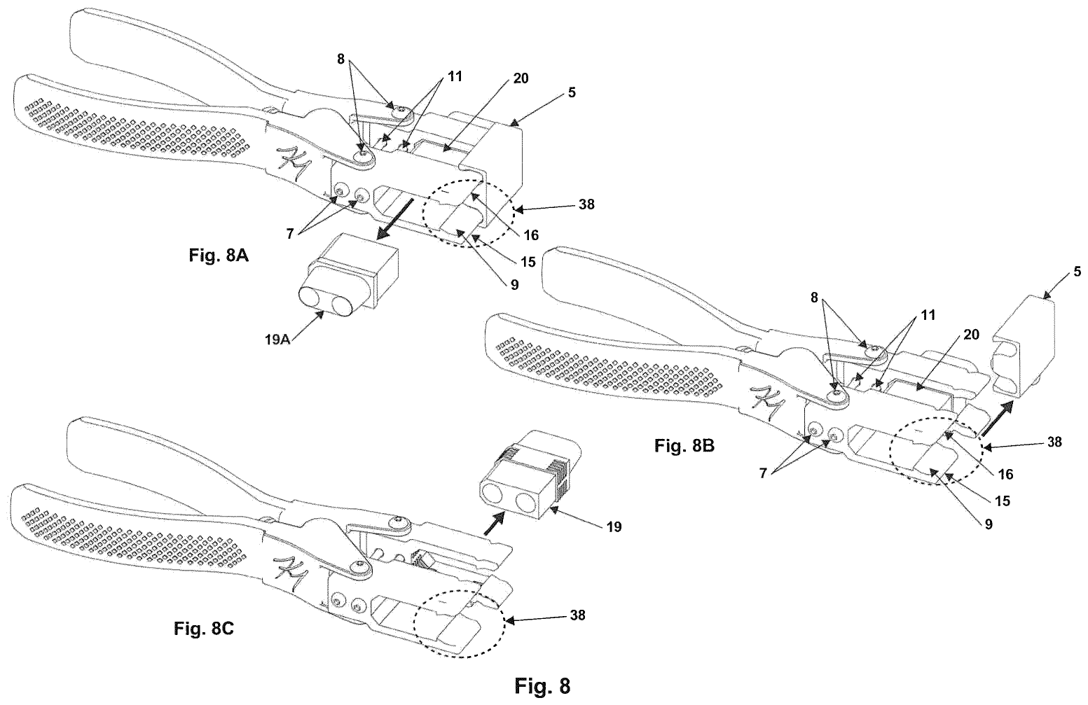

FIG. 6, through FIG. 8. Demonstrate the apparatus's operation steps.

FIG. 6. Isometric views of the apparatus mounted onto a plier-like device. Fig. A shows the insertion heads without the battery connector. The insertion chamber is shown with three walls, the right, left, and bottom walls [15] [16] and [34]. The top wall and the upper-insertion-head-cavity-wall created by the cap are lacking herein. Fig. B shows the apparatus without the cap but with the battery connector [19] inserted in the insertion chamber [9]. The battery connector is shown in Fig C with its shoulder [19A]. The battery connector is retained in place within the insertion chamber by retainer ridge/s [45] and the exact chamfered U-shape at the bottom of the chamber [46]. When the battery connector is grabbed by the retainer ridge, the battery connected is fixed within the insertion chamber, which is an initial step in the process use of separating them apart.

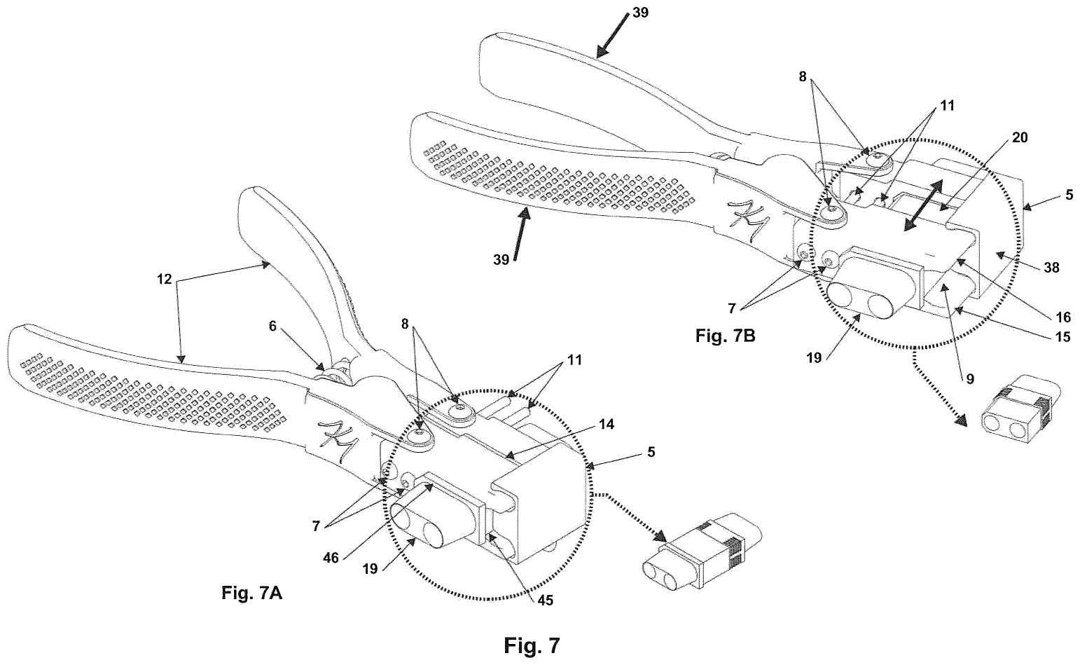

FIG. 7. Isometric views of the apparatus with battery connector mounted on a plier-like device. Fig. A shows a battery connector in the insertion chamber with the cap covering the top. Fig. B shows the insertion chambers with the battery connector and cap on the top. The cap, however, is partially detached from the insertion chamber [38]. Thus, the insertion chamber [9] is visible from the top. When the plier-like device lower end handles [1] are brought toward each other or squeezed [39], the two insertion heads [3] [4] begin to separate from each other and start to open [20] at the dividing line [14] and the pivot point [17] but are constrained with the guide pin(s) [7] & [11]. The cap [5] is constrained on one insertion head [4] but is allowed to move on the other insertion head [3]. As a result, the battery connector is separated, as shown in FIG. 8 [19A].

FIG. 8. Isometric views of the apparatus showing the removal of the battery connector. Fig. A shows the apparatus in the open position with one side of the battery connector [19] removed, and in the plier-like device, the handles at the lower ends are closest together. Fig. B shows the apparatus in the open position with one side of the connector separated and removed [19A], and the cap [5] is completely removed. Fig. C shows the apparatus in the open position with both sides of the battery connector [19] and the cap [5] removed. The apparatus is ready for reloading the battery connector and the cap for re-using the apparatus. The plier-like device handles lower ends that may be the furthest apart.

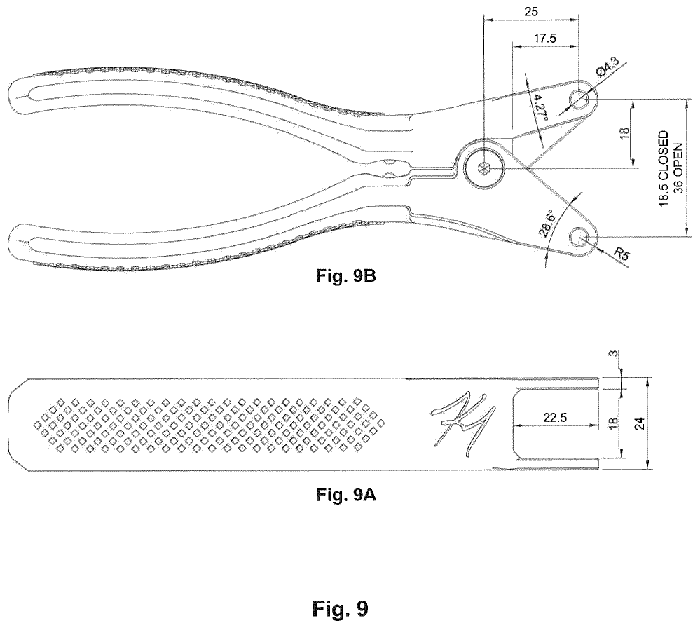

FIG. 9. Top and side views of plier-like devices with dimensions.

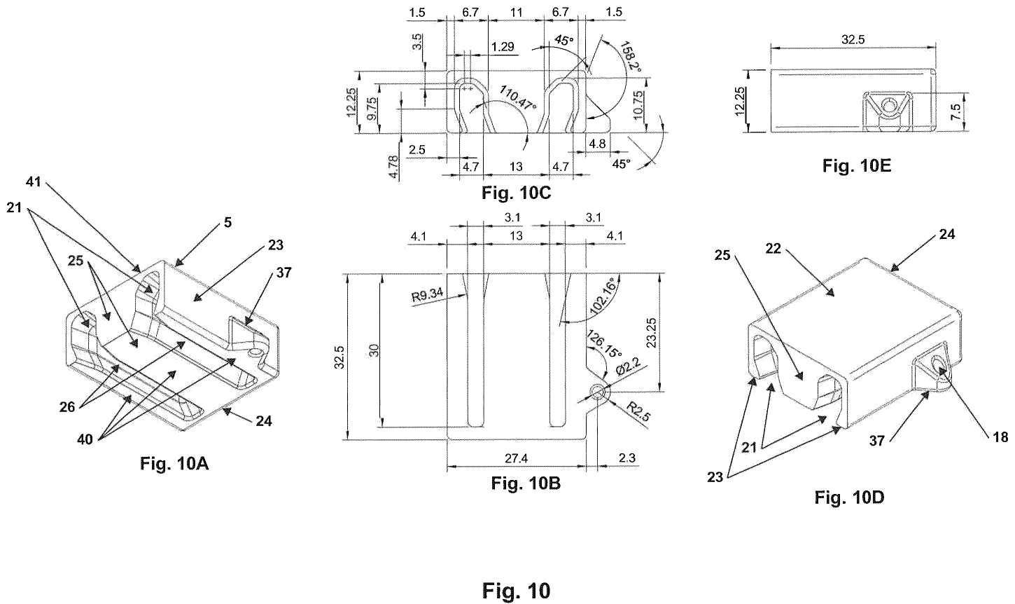

FIG. 10. Orthographic and isometric views of the cap. Fig. A is a bottom-side isometric view of the cap, and Fig. B is a bottom-side view. Fig. C is a front end-view. Fig. D is a top-side isometric view. Fig. E is a side view.

The cap is a rectangular cuboid having one top-cap-surface [22], one bottom-cap-surface [40], one back-cap-wall [24], one right-cap-wall [23], one left-cap-wall [23], and a front-cap-surface [41]. The top-cap-surface is smooth-flat [22], the bottom-cap-surface has two cavities divided by a middle-cap-wall [25], and the front-cap-surface has two openings [21]. Each opening [21] extends into each respective cavity [26]. The right-cap-wall 23], back-cap-wall [24], left-cap-wall [23] each have an outer side and an inner side, and the outer sides of right-cap-wall [23], back-cap-wall [24], left-cap-wall [23] outer walls are flat. The outer sides of left/right-cap-wall have a tethering attachment tool. This tethering attachment device on the cap [18] and [37] is used in conjunction with the insertion head's tethering attachment tool and tethering thread to make a completed tethering tool. The two cavities may be identical, mirror images of each other, non-identical, non-mirror images, etc., or any combination thereof.

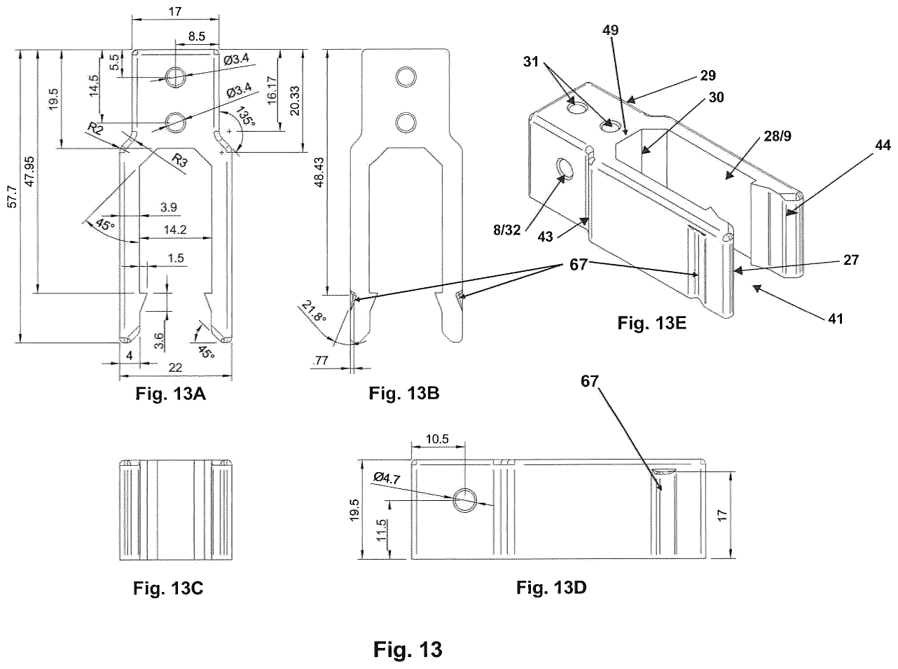

FIGS. 11 through FIG. 23. Orthographic and isometric views and side view of an insertion head embodiments with dimensions. The insertion head is made of two components; the first component is the insertion-head-cavity [28], which is configured to form one-half (50%), in this example, of the insertion chamber for the various battery connector types [9]; the second component is the guide-pin-holder [29] and serves as a mounting point [29]. The first component is made of three walls, two side walls [27] and [44], one rear wall [30], and one opening [41], creating an insertion head cavity [28], which makes up half of the insertion cavity [9]. The insertion-head-cavity is a U-shaped cavity [28], which has various features on one or both sides [27] and [44] of the insertion chamber to interface with faces and features present on the battery connectors [19], [19A], and [19B]. These features may be present on one or two side walls, the rear insertion cavity wall [30], an insertion-head-opening [41], or any combination thereof. One or more of the inner insertion-head-cavity have teeth [65], which can be customized and varied as in various embodiments. These teeth on each wall can be identical, mirror image, different, or a combination thereof between the insertion-head-cavity-walls [27, 44, 30]. Additionally, the clearance gap in the elevated lip [66] can be the same, identical, mirror image of another wall in the insertion-head-cavity or different for each wall. The lip can be elevated or not [66]. Another feature of these walls is grooves that are present on their outside [67]. These grooves assist in properly fitting the cap on the insert-heads and insertion chamber. The grooves allow the cap to stay in place [67]; FIGS. 13 & 14 is where the cap interfaces with the end of the insertion heads (67). The second component, the guide-pin-holder, is further configured to mount the insertion head/s onto the plier-like device. This second component can be a cube or a rectangular cuboid, without or with a semi-circular disc [42], elevated [47], unelevated [49], or linear [49] and is attached to the rear-insertion-head-cavity-wall [30]. The guide-pin-holder [43] and apparatus mount component have at least one adapter hole [31] for the guide pin [7, 11], and one mounting hole [32/8] configured to attach the insertion head to the plier-like device securely. The second component guide-pin-holder is aligned flush with the upper cavity wall of the insertion head [43], the lower-insertion-head-cavity-wall, and the rear-insertion-head-cavity-wall [43]. In other variations of the invention, the second guide-pin-holder component [43] is raised from the upper-insertion-head-cavity-wall [27], lower-insertion-head-cavity-wall [44], and rear-insertion-head-cavity-wall [30]. All dimensions given in the figures and the insertion of head cavity features may be critical for the operation of the various apparatus embodiments to allow the separation of their respective commercially available battery connectors. In some cases, removing one or more features may reduce the operating effectiveness of the apparatus.

The first component is made of a left/lower insertion-head-cavity-wall [44], a right/upper insertion-head-cavity-wall [27] cavity wall, and a semi-circular rear cavity wall [30]. The insertion head cavity is a U-shaped cylindrical cavity [28] that has a flat and straight upper-insertion-head-cavity-wall [27], a flat and straight lower-insertion-head-cavity-wall [44], a semi-circular-back-insertion-head-cavity-wall [30] and an insertion-head-side-opening [41]. The second component guide-pin-holder can be a cube or a rectangular cuboid with a semi-circular disc [42], without semi-circular but with flat [48], elevated [47], or unelevated, flushed [49], and is attached to the semi-circular-back-insertion-head-cavity-wall on the front end. The second guide-pin-holder component has at least one adaptor hole for the guide pin [31], and at least one mounting hole [32/8] configured to attach the insertion head to the plier-like device securely. The alignment between the first insertion head cavity and the second component guide-pin-holder is flushed. This flushed alignment may extend between the second component and all three walls of the first

component, namely the upper insertion head cavity wall [27], the lower-insertion-head-cavity-wall [44], and the semi-circular-back-insertion-head-cavity-wall [43]. In another aspect of the invention, the second guide-pin-holder component is not flushed but is elevated or raised from the upper-insertion-head-cavity-wall [27], lower-insertion-head-cavity-wall [44], and semi-circular-back-insertion-head-cavity-wall-[42].

FIG. 11. Orthographic and isometric views of the insertion heads with dimensions. This insertion head is for use with flat tab, typically black in color, connectors. Features unique to this insertion head cavity are the elevated protruding tab on the left cavity wall [44] and, an elevated protruding wall on the rear [30], and the right insertion cavity wall [27]. These features are used to position, secure, and ultimately separate the flat tab, typically black in color, battery connector. The inner insertion-head-cavity has teeth [65], as shown in the Fig. E view. One additional insertion head with mirrored dimensions is required to complete the apparatus.

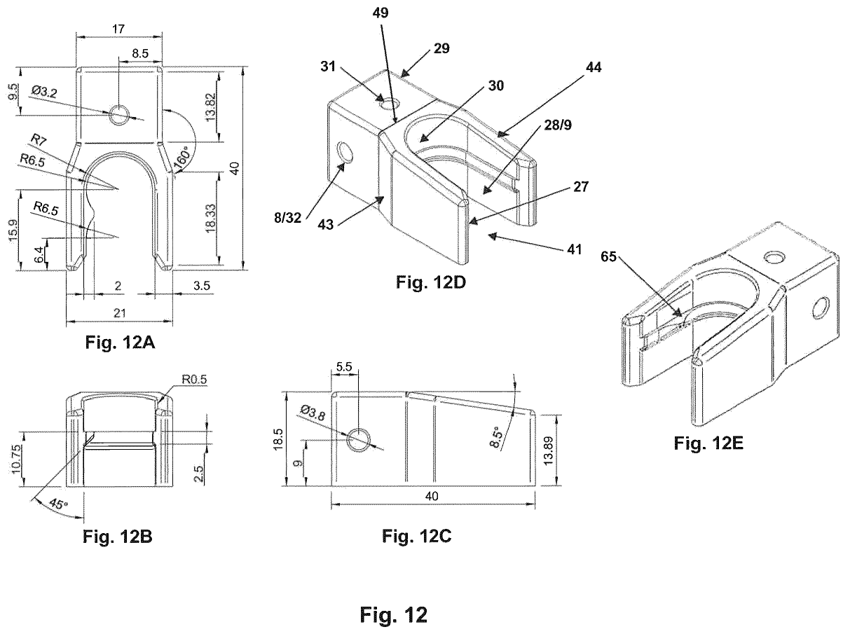

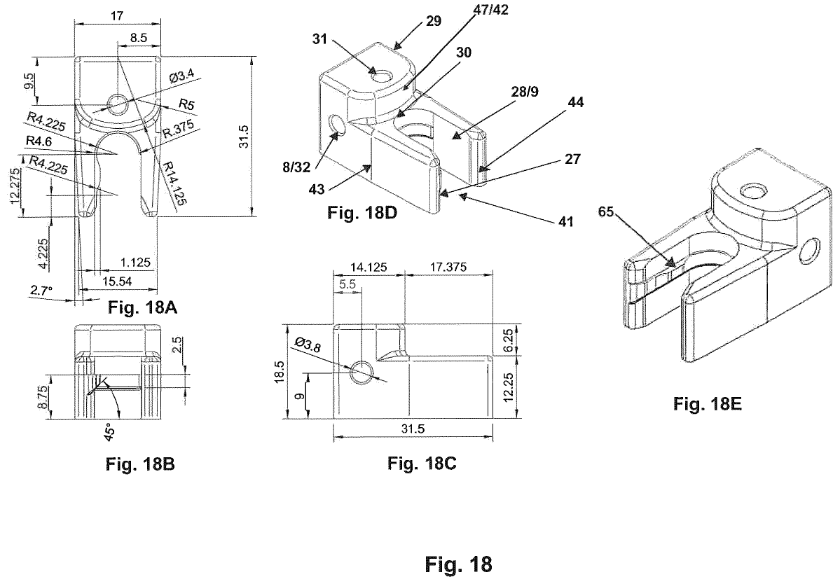

FIG. 12. Orthographic and isometric views of the insertion heads with dimensions for use with 6.0 mm diameter, typically pale green in color, connectors. Features unique in size but similar in shape to features shown in FIG. 18 are the elevated protruding tab on the left cavity wall [44] that joins to a thinner elevated protruding lip that continues around the curved rear cavity wall [30] and to the right insertion cavity wall [27]. These features position, secure, and ultimately separate the 6.0 mm diameter, typically pale green in color, battery connector. Another feature of these walls is grooves that are present on their outside [67]. The inner insertion-head-cavity has teeth [65], as shown in the Fig. E view. One additional insertion head with mirrored dimensions is required to complete the apparatus.

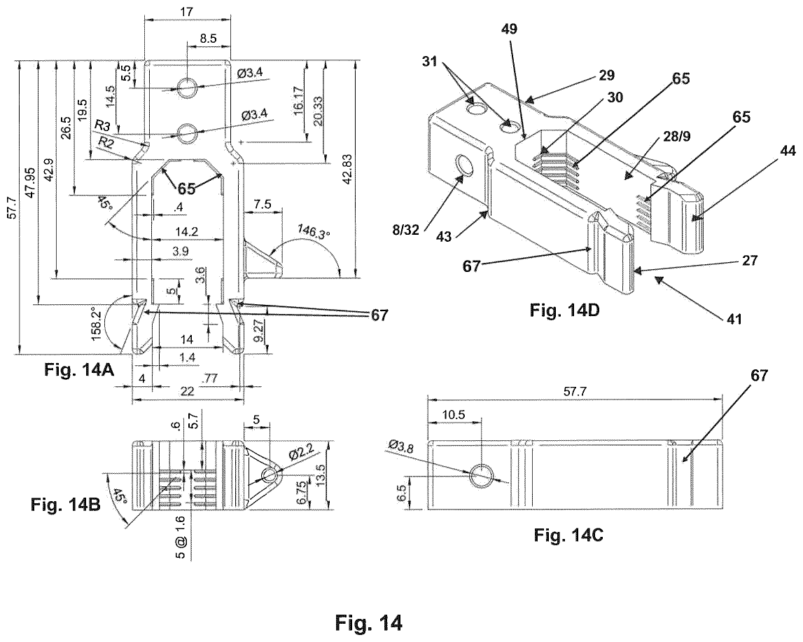

FIG. 13. Orthographic and isometric views of the insertion heads with dimensions for use with 8.0 mm diameter, typically black in color, connectors. Features used in this insertion head cavity are two retention teeth on the left [44] and right [27] cavity walls and a half-octagonal-shaped rear insertion chamber wall [30]. These features are shared with features in FIG. 14 and are used to position, secure, and ultimately separate the 8.0 mm diameter, typically black in color, battery connector. There are also two inset grooves on the outside walls of the insertion head to allow the apparatus cap to slide onto the end of the insertion head; the grooves are present on the outside of the walls [67]. These features are used to position, secure, and ultimately separate the 8.0 mm diameter, typically black in color, battery connector. This insertion head is used in conjunction with the insertion head shown in FIG. 14 and the cap shown in FIG. 10 to make a completed apparatus.

FIG. 14. Orthographic and isometric views of the insertion heads with dimensions for use with 8.0 mm diameter, typically black in color, connectors. Features used in this insertion head cavity are two retention teeth on the left and right cavity walls [44] & [27] and a half-octagonal-shaped rear insertion chamber wall [30]. These features are shared with features in FIG. 13. Features unique to this insertion head are four sets of five gripping teeth on the left [44], right [27], and half-octagonal rear wall [30]. These features are used to position, secure, and ultimately separate the 8.0 mm diameter, typically black in color, battery connector. This insertion head is used in conjunction with the insertion head shown in FIG. 13 and the cap shown in FIG. 10 to make a completed apparatus.

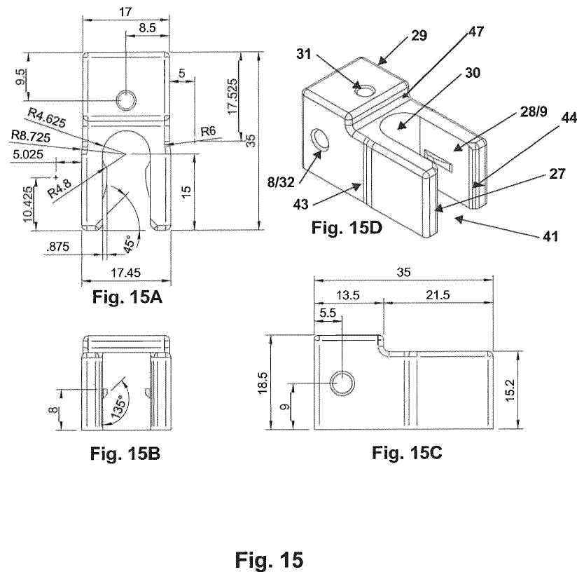

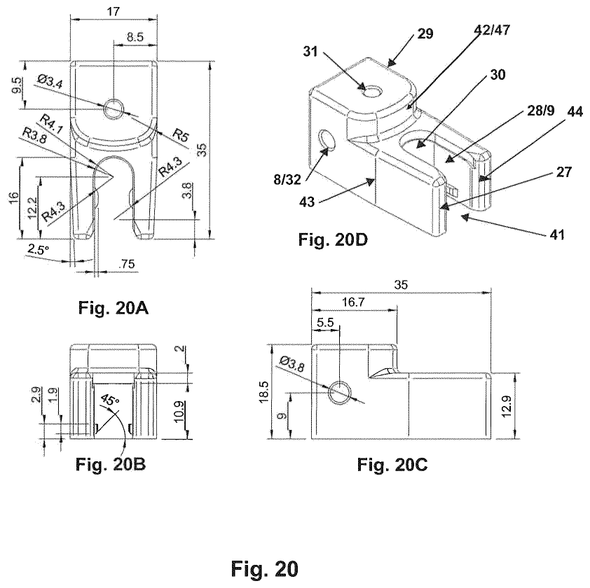

FIG. 15. Orthographic and isometric views of the insertion heads with dimensions for use with 5.0 mm diameter, typically blue in color, connectors. Features unique in size but similar in shape to features shown in FIG. 20 are thin, elevated protruding tabs on the left [44] and right [27] insertion chamber walls with a rounded rear wall [30]. These features are used to position, secure, and ultimately separate the 5.0 mm diameter, typically blue in color, battery connector. One additional identical insertion head is required to complete the apparatus.

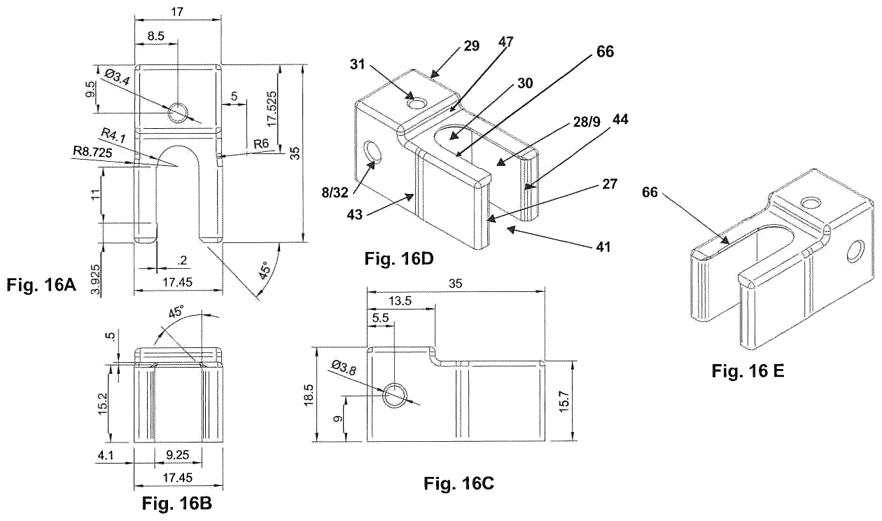

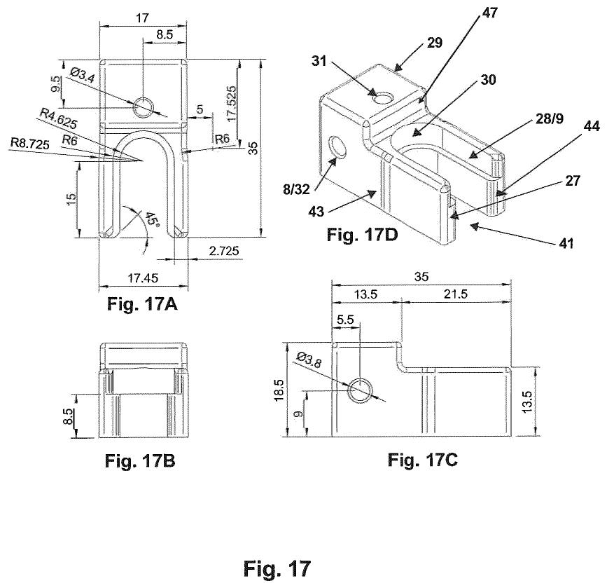

FIG. 16. Orthographic and isometric views of the insertion heads with dimensions for use with 5.0 mm diameter, typically blue in color, and 5.0 mm diameter, typically orange in color, combination style connectors. Features unique to this insertion head cavity are an elevated lip at the top of the insertion chamber starting on the front left side of the chamber [44], absent for part of the left side of the chamber, present for the left rear of the chamber, and continuing around the rounded rear of the chamber [30] and completely across the right side of the chamber [27]. These features are used to position, secure, and ultimately separate 5.0 mm diameter, typically blue in color & 5.0 mm diameter, typically orange in color, battery connectors when they are used together. The clearance gap in the elevated lip [66] is shown in Fig. E. One additional insertion head, shown in FIG. 17, is required to complete the apparatus.

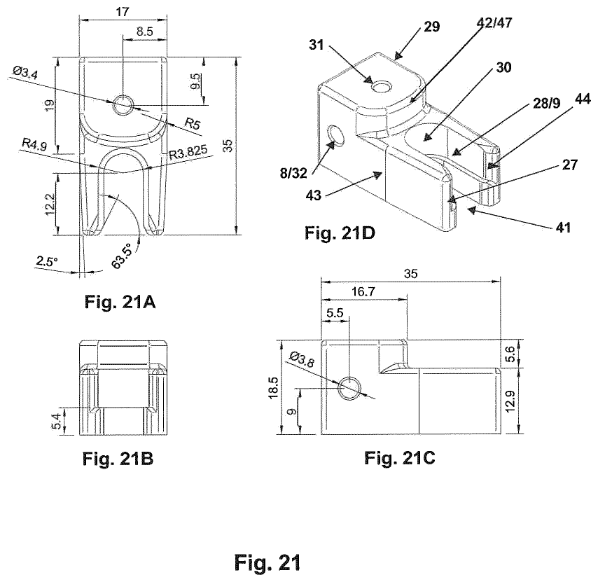

FIG. 17. Orthographic and isometric views of the insertion heads with dimensions for use with 5.0 mm diameter, typically orange in color, connectors. Features unique in size but similar in shape to features shown in FIG. 21 are a thin elevated face that is continuous from the left insertion chamber wall [44], around the rounded rear chamber wall [30], and along the right chamber wall [27]. These features are used to position, secure, and ultimately separate the 5.0 mm diameter, typically orange in color, battery connector. One additional identical insertion head is required to complete the apparatus.

FIG. 18. Orthographic and isometric views of the insertion heads with dimensions for use with 4.0 mm diameter, typically pale green in color, connectors. Features unique in size but similar in shape to features shown in FIG. 12 are the elevated protruding tab on the left insertion chamber wall [44] that joins to a thinner elevated protruding lip that continues around the curved rear cavity wall [30] but is absent on the right insertion cavity wall [27]. These features are used to position, secure, and ultimately separate the 4.0 mm diameter, typically pale green in color, battery connector. The inner insertion-head-cavity has teeth [65], as shown in the Fig. E view. One additional insertion head with mirrored dimensions is required to complete the apparatus.

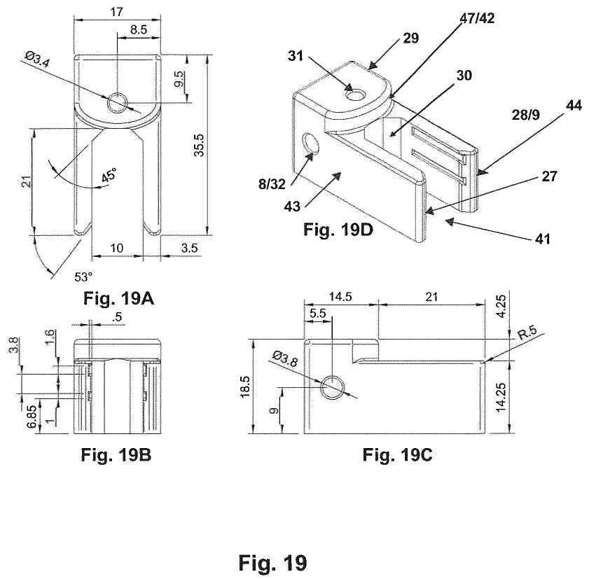

FIG. 19. Orthographic and isometric views of the insertion heads with dimensions for use with normal and anti-spark 4.6 mm diameter, typically yellow in color, connectors. Features unique to this insertion head cavity are two slots at different elevations that run the length of the left [44] and right [27] sides of the insertion chamber along with a half-octagonal rear chamber wall [30] that is similar in shape but different in size to the rear insertion chamber wall in FIG. 13 and FIG. 14. These features are used to position, secure, and ultimately separate normal and anti-spark 4.6 mm diameter, typically yellow in color, battery connectors. One additional identical insertion head is required to complete the apparatus.

FIG. 20. Orthographic and isometric views of the insertion heads with dimensions for use with 3.0 mm diameter, typically blue in color, connectors. Features unique in size but similar in shape to features shown in FIG. 15 are thin, elevated protruding tabs on the left [44] and right [27] insertion chamber walls with a rounded rear insertion chamber wall [30]. These features are used to position, secure, and ultimately separate the 3.0 mm diameter, typically blue in color, battery connector. One additional identical insertion head is required to complete the apparatus.

FIG. 21. Orthographic and isometric views of the insertion heads with dimensions for use with 3.0 mm diameter, typically orange in color, connectors. Features unique in size but similar in shape to features shown in FIG. 17 are a thin elevated face that is continuous from the left insertion chamber wall [44], around the rounded rear chamber wall [30], and to the right chamber wall [27]. These features are used to position, secure, and ultimately separate the 3.0 mm diameter, typically orange in color, battery connector. One additional identical insertion head is required to complete the apparatus.

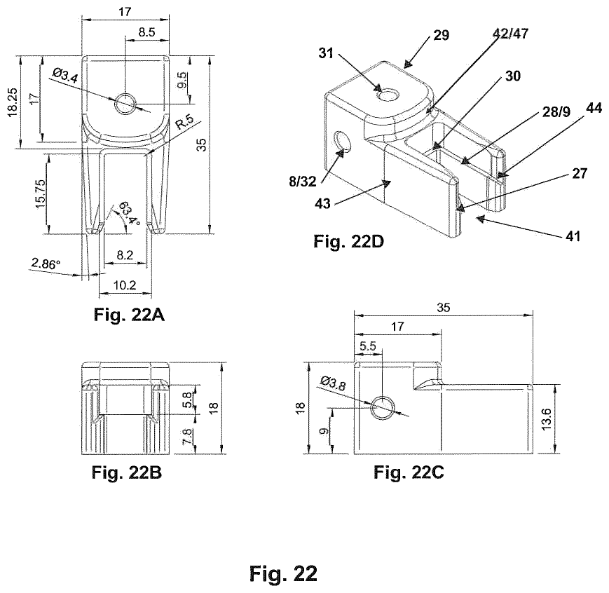

FIG. 22. Orthographic and isometric views of the insertion heads with dimensions and for use with anti-spark 3.6 mm diameter, typically yellow in color, connectors. The features unique to this insertion head are a rectangular insertion cavity with an elevated lip, flat left [44], right [27], and rear [30] cavity walls with a small fillet connecting the walls. These features are used to position, secure, and ultimately separate the anti-spark 3.6 mm diameter, typically yellow in color, battery connector. One additional identical insertion head is required to complete the apparatus.

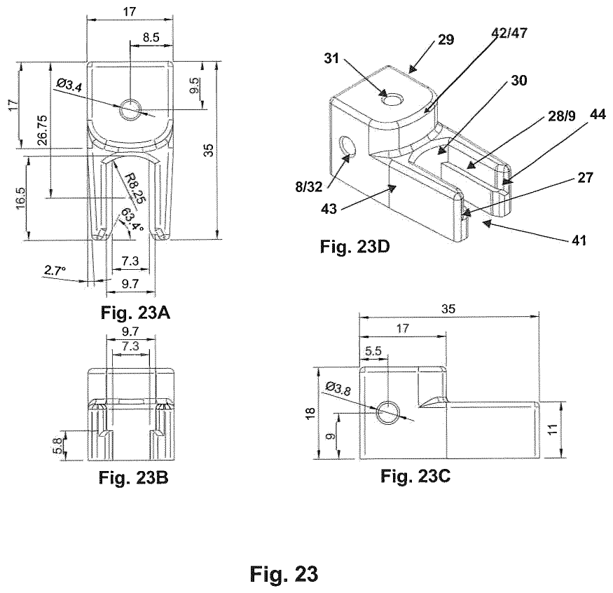

FIG. 23. Orthographic and isometric views of the insertion head with dimensions for use with Anti-Spark T-Plug, typically red in color, style connectors. Features unique to this insertion head cavity are an elevated lip on both the left [44] and right [27] cavity walls and a semi-circular rear cavity wall [30]. These features are used to position, secure, and ultimately separate the electrical connectors. These features are used to position, secure, and ultimately separate the Anti-Spark T-Plug, typically red in color, style connector. One additional identical insertion head is required to complete the apparatus.

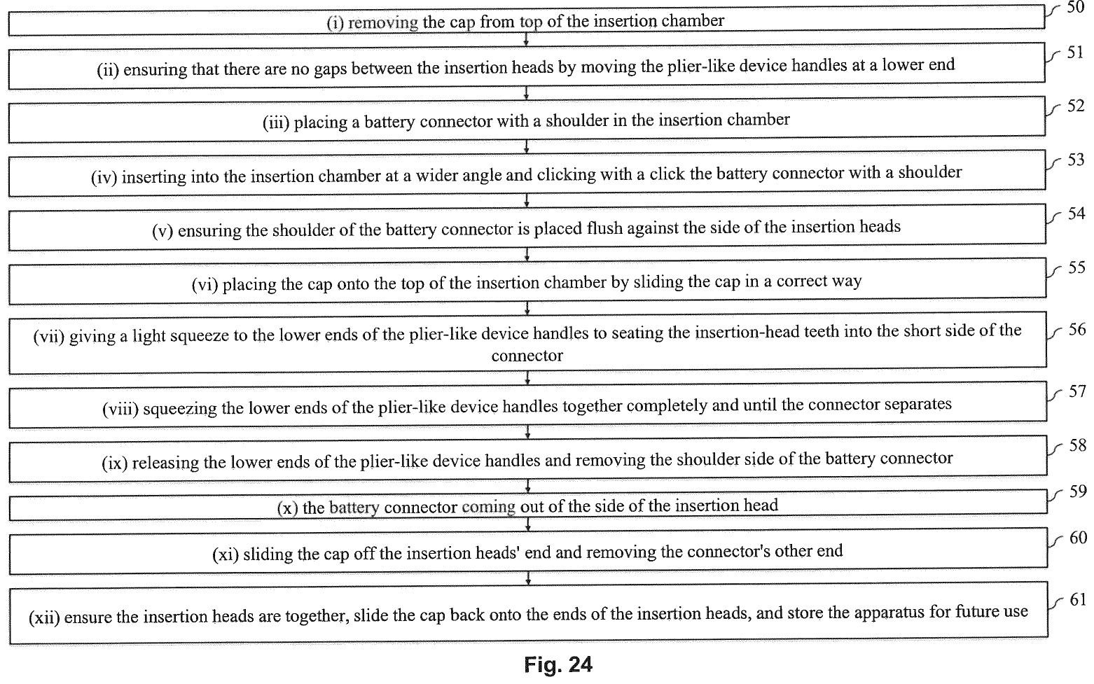

FIG. 24. Method of use for the battery connector separation apparatus. The first step, locate the end of the connector that has the “shoulder” [19A] on it, slide the cap off of the end of the insertion heads, which is hanging loosely on the attached tether, and make sure the insertion heads are in the “closed” position (if there is a gap between the insertion heads, open the handles and ensure the gap is closed), insert the battery connector (for example, QS8 connector into the ends of the insertion heads), making sure to insert the end of the connector with the “shoulder” into the wider of the two insertion heads. The connector should sit in place with a “click.” ensure the “shoulder” of the connector is seated flush against the side of the insertion head and slide the cap onto the ends of the insertion heads until it is fully seated. The cap is designed so that it will only go on the insertion heads one way, give a light squeeze of the handles to seat the teeth of the small insertion head into the connection-grooves of the short side of the connector, squeeze the handles together fully, or until the connector separates, release the handles and remove the “shoulder” side of the connector, and it will now come out of the side of the insertion head, slide the cap off the insertion heads' end and remove the connector's other end, make sure the insertion heads are together, slide the cap back onto the ends of the insertion heads, and store the apparatus for future use.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. The battery connector separation apparatus comprising two insertion heads, one cap, one insertion chamber, and at least one guide-pin,
wherein the two insertion heads are flush aligned and parallel to each other, and the one cap is horizontally aligned to the two insertion heads configured to form the one insertion-chamber, and
wherein the apparatus is configured to mount onto a plier-like device.

2. The apparatus of claim 1, wherein the insertion chamber is 8.2 to 17.0 mm wide, 15.75 to 38.2 mm long, and 13.5 to 19.5 mm deep.

3. The apparatus of claim 1, wherein the plier-like device further comprises two handles, one pivot point, and two jaws, wherein each handle has an upper-handle-end and lower-handle-end, wherein each jaw has an upper-jaw-end and a lower-jaw-end, where two lower-jaw-end of the two jaws and the upper-handle-ends of the two handles are connected together at the pivot point, and wherein one compression spring is placed between the two upper-handle-ends and below the pivot point.

4. The apparatus of claim 3, wherein the jaws comprise at least one mounting bolt on each jaw configured to mount securely by the mounting bolts, wherein the mounting bolts are M4×10.

5. The apparatus of claim 3, wherein the compression spring is 12 mm×30 mm.

6. The apparatus of claim 1, wherein the one cap comprises a rectangular cuboid, wherein the rectangular cuboid has one top-cap-surface, one bottom-cap-surface, one back-cap-wall, one right-cap-wall, one left-cap-wall, and a front-cap-surface, wherein the top-cap-surface is smooth-flat, the bottom-cap-surface has two cavities divided by a middle-cap-wall, wherein the front-cap-surface has two openings, wherein each opening extends into the each cavity.

7. The apparatus of claim 6, wherein right-cap-wall, back-cap-wall, left-cap-wall each has an outer side and an inner side, wherein the outer sides of right-cap-wall, back-cap-wall, left-cap-wall outer walls are flat, and wherein the outer sides of left/right-cap-wall has a tethering tool.

8. The apparatus of claim 6, wherein the two cap cavities are parallel to each other, wherein each cavity is U-shaped and cylindrical shaped.

9. The apparatus of claim 6, wherein each cavity is 27.4 mm wide, 32.5 mm long and 12.25 mm deep.

10. The apparatus of claim 6, wherein the bottom-cap-surface two cavities fit into the two insertion heads.

11. The apparatus of claim 1, wherein the insertion head comprises at least two components, wherein the first component is an insertion-head-cavity configured to form half of the one insertion chamber, and wherein a second component is a guide-pin-holder.

12. The apparatus of claim 11, wherein the guide-pin-holder is a rectangular cuboid.

13. The apparatus of claim 11, wherein the first component further compromises a U-shaped cylindrical cavity comprising an upper-insertion-head-cavity-wall, a lower-insertion-head-cavity-wall, a semi-circular-back-insertion-head-cavity-wall, and two insertion-head-side-openings and one insertion-head-font-opening, and wherein the upper-insertion-head-cavity-wall and the lower-insertion-head-cavity-wall are flat.

14. The apparatus of claim 11, wherein the second guide-pin-holder component is attached to a semi-circular-back-insertion-head-cavity-wall of the insertion-head-cavity, and wherein the second guide-pin-holder component has at least one adaptor hole for a guide pin, and at least one mounting hole configured to attach the insertion head to the plier-like device securely.

15. The apparatus of claim 11, wherein the second guide-pin-holder component is a cube.

16. The apparatus of claim 12, wherein the second guide-pin-holder component has a rectangular cuboid structure.

17. The apparatus of claim 11, wherein the second guide-pin-holder component is aligned flushed with an upper-insertion-head-cavity-wall of the insertion-head-cavity, a lower-insertion-head-cavity-wall of the insertion-head-cavity, and a semi-circular-back-insertion-head-cavity-wall of the insertion-head-cavity.

18. The apparatus of claim 11, wherein the second guide-pin-holder component is raised from an upper-insertion-head-cavity-wall of the insertion-head-cavity, lower-insertion-head-cavity-wall of the insertion-head-cavity, and semi-circular-back-insertion-head-cavity-wall of the insertion-head-cavity.

19. The apparatus of claim 11, wherein the second component guide-pin-holder is U-shaped.

20. The apparatus of claim 11, wherein the second component guide-pin-holder component is 17 mm wide, 17 to 19.5 mm long, with a depth of 17.5 to 18.5 mm.

21. The apparatus of claim 11, wherein the first component is 15.4 to 22.0 mm wide, 15.75 to 38.2 mm long, and 11 to 19.5 mm tall.

22. The method of use of a battery separator apparatus comprising two insertion heads, one cap, one insertion chamber, and at least one guide-pin, wherein the two insertion heads are flushed aligned and parallel to each other, and the cap is horizontally aligned to the two insertion heads configured to form the one insertion chamber, wherein the apparatus is configured to mount onto a plier-like device with two handles with a lower and an upper-handle-ends, and the method comprising the steps:
i) removing the cap from top of the insertion chamber,
ii) ensuring that there are no gaps between the insertion heads by moving the plier-like device handles at a lower end,
iii) placing a battery connector with a shoulder in the insertion chamber,
iv) inserting into the insertion chamber at a wider angle and clicking with a click the battery connector with a shoulder,
v) ensuring the shoulder of the battery connector is placed flush against the side of the insertion heads,
vi) placing the cap onto the top of the insertion chamber by sliding the cap in a correct way,
vii) giving a light squeeze to the lower ends of the plier-like device handles to seating the insertion-head teeth into the short side of the connector,
viii) squeezing the lower ends of the plier-like device handles together completely and until the connector separates,
ix) releasing the lower ends of the plier-like device handles and removing the shoulder side of the battery connector,
x) the battery connector coming out of the side of the insertion head,
xi) sliding the cap off the insertion heads' end and removing the connector's other end, and
xii) ensure the insertion heads are together, slide the cap back onto the ends of the insertion heads, and store the apparatus for future use.
